(19) United States
(12) Patent Application Publication
(10) Pub. No.: US 2014/0122210 A1
(43) Pub. Date: May 1, 2014

(54) SYSTEMS AND METHODS FOR DELIVERING AND REDEEMING ELECTRONIC COUPONS

(71) Applicant: MobileBits Corporation, Sarasota, FL (US)

(72) Inventors: Andrew C. MARSHALL, Frick (CH); Andre LAMBELET, Sarasota, FL (US); Stefan BACHMAN, Bennau (CH)

(73) Assignee: MobileBits Corporation, Sarasota, FL (US)

(21) Appl. No.: 14/065,014

(22) Filed: Oct. 28, 2013

Related U.S. Application Data
(60) Provisional application No. 61/719,341, filed on Oct. 26, 2012.

(51) Int. Cl. G06Q 30/02

(52) U.S. Cl. CPC G06Q 30/0225
USPC 705/14.26

(57) ABSTRACT

A method of verifying the authenticity of an electronic coupon is described. The method includes transmitting the electronic coupon to a mobile device of a consumer and verifying the authenticity of the electronic coupon. The electronic coupon includes an image with one or more visual elements for display on the mobile device at least one of which is capable of moving when activated by a user of the electronic device. Observation of the movement of the moving visual element after activation confirms the authenticity of the electronic coupon. A computer readable medium comprising instructions to manipulate a processor is also described. The medium includes instructions to send display data for an electronic coupon image including one or more visual elements as described above to a mobile device of a consumer and instructions to activate the moving visual element when an input is received from a user of the mobile device.

### CROSS REFERENCE TO RELATED APPLICATIONS

This application claims the benefit of Provisional U.S. Application Ser. No. 61/719,341, filed Oct. 26, 2012, pending, which is incorporated by reference herein in its entirety.

### BACKGROUND

1. Field

The present disclosure relates generally to advertising and marketing systems, and more particularly to methods and systems for the delivery of electronic coupons to mobile devices and authentication of the coupons.

2. Background of the Technology

Mobile devices (e.g., cellular phones, smartphones, PDAs, tablet computers, etc.) have become ubiquitous personal items that are carried by the vast majority of the population. These mobile devices are generally capable of a variety of tasks (in addition to making telephone calls), including browsing the Internet, downloading and using software applications (or “apps”), messaging (e.g., “text” messaging in the form of SMS and MMS messages), performing emailing and calendaring functions, and a variety of other functionalities.

Due to a typical person's frequent interaction with his or her mobile device, companies and marketers have identified mobile devices as a fertile ground for advertising and delivering other types of content including electronic coupons or vouchers. Conventional electronic coupons, however, can be easily duplicated and forwarded to consumers other than the intended recipient. For example, a screen shot can be taken of the coupon image and used multiple times as a “fake” coupon. Even the addition of moving or animated images to an electronic coupon can be readily duplicated by recording a video of the animated content and replaying the recording to a merchant during an unauthorized redemption.

Various methods of preventing unauthorized duplication or use of electronic coupons have been proposed, including using a number countdown on the redemption screen of the mobile device to provide a time limit for redemption and requiring an authentication code unknown to the consumer to confirm authenticity. Number countdowns, however, can be easily reprogrammed, thereby enabling fake coupons to be redeemed many numbers of times. This fake couponing practice not only significantly impacts a retailer's bottom line, but also causes inaccuracies in determining a given coupon's or marketing campaign's effectiveness. In addition, requiring security codes requires additional time at the point of sale and mistakes made in entry of the code by the consumer or merchant can cause frustration by the consumer thereby reducing rather than increasing sales.

Accordingly, there is a long-felt but unresolved need for a system or method that is able to effectively distribute electronic coupons or vouchers to the mobile devices of consumers which can be readily redeemed by the consumer and authenticated by a third party at the point of sale.

### SUMMARY

A method of verifying the authenticity of an electronic coupon is provided which comprises:

transmitting the electronic coupon to a mobile device of a consumer, the electronic coupon comprising an image which comprises one or more visual elements displayed on the screen of the mobile device, wherein at least one of the visual elements is a moving visual element capable of moving when activated by a user of the electronic device; and
verifying the authenticity of the electronic coupon, wherein verifying comprises activation of the electronic coupon upon presentation of the electronic coupon by the consumer, wherein observation of the movement of the moving visual element upon activation confirms the authenticity of the electronic coupon.

A computer readable medium comprising instructions to manipulate a processor is also provided which comprises instructions to:
send display data for an electronic coupon image to the mobile device of a consumer, wherein the display data comprises one or more visual elements displayed on the screen of the mobile device, wherein at least one of the visual elements is a moving visual element capable of moving when activated by a user of the electronic device; and activate the moving visual element when an input is received from a user of the mobile device.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic of a digital security pseudo-hologram comprising a header bar, a pseudo-hologram image and a footer bar.

FIGS. 2 is a schematic showing a digital security pseudo-hologram comprising a first layer displaying the current year, a second layer displaying an application icon which is fixed, a third layer displaying the icon's shading which is movable is response to a user input and a pseudo-3D image which is fixed.

FIG. 3 is a schematic showing a digital security pseudo-hologram comprising multiple layers as set forth in FIG. 2 wherein the icon shading layer is movable in response to gyroscope and accelerometer information of the mobile device.

FIG. 4 is a schematic showing a digital security pseudo-hologram which is touch-sensitive, wherein the image on the mobile device rotates when the user activates the image.

FIGS. 5A-5C illustrate exemplary mobile device screens showing exemplary electronic coupons displayed thereon, according to one embodiment of the present disclosure.

### DESCRIPTION OF THE VARIOUS EMBODIMENTS

Overview

Security holograms are well documented in the art. Traditionally, security holograms are used to prove the authenticity of a product. They are very difficult to forge because they are replicated from a master hologram, which requires specialized knowledge. Security holograms are used in a multitude of banknotes in the world, as well as in passports, credit cards and on a multitude of quality products. Several types of security holograms are used, among which are the kinetic images. A kinetic image is an image that is modified when the conditions of observation are changed. Turning or inclining the hologram allows the movements of certain features of the images to be studied.

To prove quickly and efficiently to a third-party that the content displayed on the screen of a smartphone is real and authentic, embodiments of the present disclosure relate to a digital security pseudo-hologram (DSPH). The only way to prove quickly that a user is not showing a screenshot or a video of the content (electronic coupon) that could have been modified is to have encrypted information moving and actionable on the screen which would ensure the third-party that the content is authentic. In addition, for third parties that seek single-use campaigns, it is possible to integrate a countdown or other security mechanism in addition to the hologram, which removes the specific content from the mobile device to ensure one-time use.

Previous solutions have employed only a number countdown method on the redemption screen of a mobile device or for the third-party to type a specific number unknown to the user to confirm authenticity. Both these methods have specific challenges that are overcome by the present embodiments, including:

1. Using the specific number input method requires time at the point of sales by the cashier employee and/or the customer when entering numbers along with potential errors, which can further prolong the process and reduces revenue transactions.

2. A number countdown method alone does not overcome security issues as such countdowns can be easily re-programmed enabling the coupon content to be abused by users of the coupon campaign.

Aspects of the present disclosure easily and quickly allow any third-party to confirm that any mobile content (e.g., electronic or digital coupons) presented to them is real and current by simply tapping on the dynamic hologram (i.e., interacting with a user interface of a mobile device) and seeing the content move or rotate. A static picture or copy of the content would not rotate and would be fixed, therefore indicating that the content is either a copy or not valid for more than one use. Further, traditional moving content (e.g., countdowns or moving icons) move continuously and thus are not dependent upon user interaction with the device.

Thus, in one embodiment, aspects of the presently-described digital hologram are activated based on a user's interaction with an interface on a mobile device that is displaying the hologram. For example, a user can touch the hologram (or other presented image), which will cause the hologram/image to move or rotate. In certain embodiments, if the user again taps or touches the image, the image will stop moving. In further embodiments, the movement of the hologram coincides with the speed of the movement of the mobile device user's interaction with the user interface screen. For example, if a user swipes his or her finger over the digital hologram quickly, then the hologram might spin rapidly. If the user moves his or her finger in a circular motion over the digital hologram, then the hologram might move in a direction that tracks the user's finger movement. Other similar movements and visual indicators of interaction will be apparent to one of ordinary skill in the art.

In further embodiments, the DSPH is programmed such that it is operatively tied to the physical movement of the mobile device. In particular and in certain embodiments, mobile devices are equipped with accelerometers and gyroscopes. As will be understood by one of ordinary skill in the art, an accelerometer is a device that measure acceleration, and a gyroscope is a device for measuring or maintaining orientation, based on the principles of angular momentum. Many current mobile devices (e.g., smartphones, tablet computers, etc.) are equipped with accelerometers and gyroscopes to allow screen positions to move or rotate depending on the physical positioning of the mobile device. Thus, aspects of the present disclosure utilize proprietary algorithms built within an application that presents digital coupons to leverage the accelerometer and gyroscope functionality to move and rotate DSPHs in concert with the physical movement of the mobile device. For example, if a mobile device displaying a DSPH is tilted in one direction, the DSPH may tilt (as displayed on the mobile device screen) in a concurrent or opposite direction. If the mobile device is rotated, then the DSPH might rotate correspondingly. In this way, it becomes very clear to a third party viewing the electronic coupon that the coupon is active, as the DSPH shown on the coupon will move on command with the mobile device.

Therefore, aspects of the present disclosure overcome the time delays, potential human error and any chance of forgery through a digital hologram method, which is imbedded in the digital coupon content shown on a mobile device user interface. Further, non-limiting aspects and examples of the present disclosure will be described in greater detail below.

### EXEMPLARY EMBODIMENTS

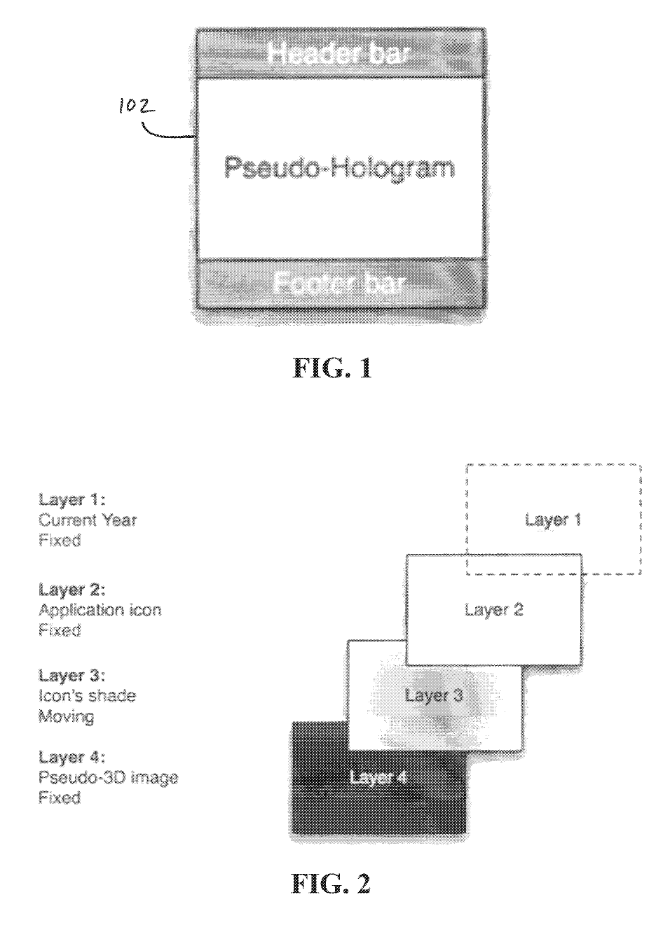

Referring to FIG. 1, an exemplary representation of a digital security pseudo-hologram (DSPH) 102 shown on a representative mobile device screen is provided. In the embodiment shown, the representation includes a header bar, a pseudo-hologram image and a footer bar. According to some embodiments, the header bar can display the content's title. The text of the header bar can be continuously sliding from right to left. The speed at which the text is sliding can be defined in a manner that the whole text is displayed in a specific number of seconds before it starts again. This timing can be identical to the one used in the footer bar and for the DSPH rotation.

In one embodiment, all the specific information of the content is also integrated into the dynamic hologram. For example, the content's title may be displayed in a top bar, and the current UTC date and time may be displayed in a bottom bar, etc. Further, the current year may be displayed over the bottom bar, overlaying the text and icon. Again, when the DSPH is touched or otherwise manipulated via some physical interaction with the mobile device or interface displaying the DSPH, the DSPH reacts in a predetermined and corresponding manner to indicate that the electronic content is live.

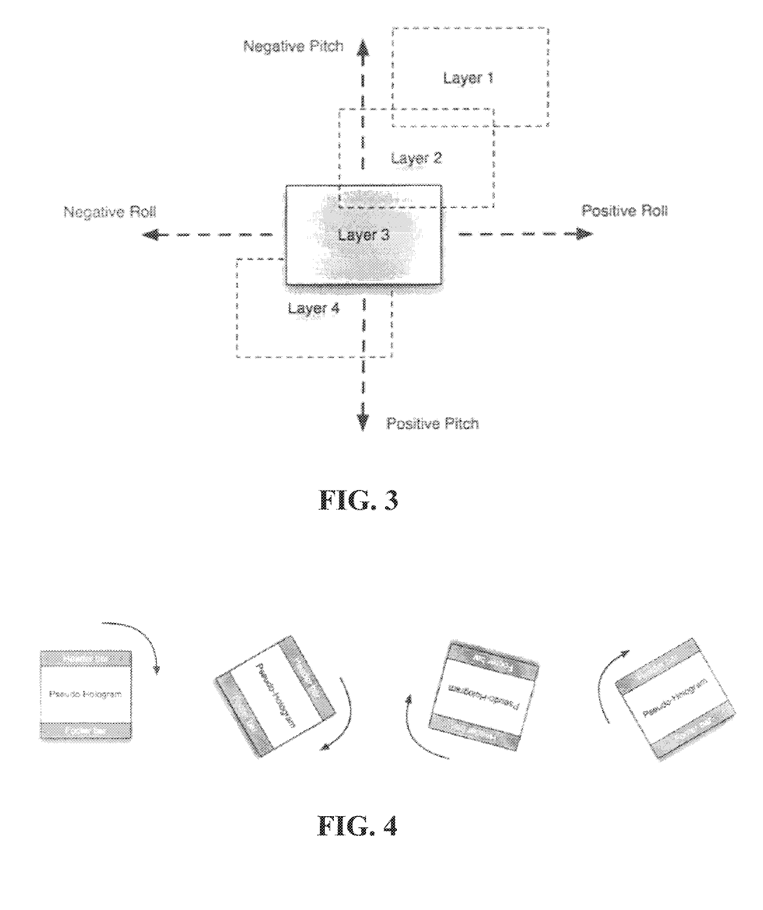

In one embodiment and as shown in FIG. 2, the pseudo-hologram image can be formed by a plurality of superposed layers. The specific and non-limiting example in FIG. 2 includes four layers, but as will be understood and appreciated by one of ordinary skill in the art, any number of layers can be used. As shown in FIG. 2, the top layer (1) is used to display the current year, the icon layer (2) comprises the icon of the given coupon application with a transparent background, the shade layer (3) comprises the shade of the icon layer and the background layer (4) is a pseudo-3D image. In the embodiment shown, each of the first three layers can have a transparent background in order to be able to see the Pseudo-3D image as background of the pseudo-hologram.

As shown in FIG. 2, the first layer can be static and formed by the current year displayed as text on top of the other images at the bottom right of the DSPH. According to some embodiments, the size of the text displayed can fit within half the width of the DSPH.

As shown in FIG. 2, the second layer is static and formed by the application's icon. According to some embodiments, the icon is displayed in gray scale in order to clearly see the security elements of the DSPH behind it.

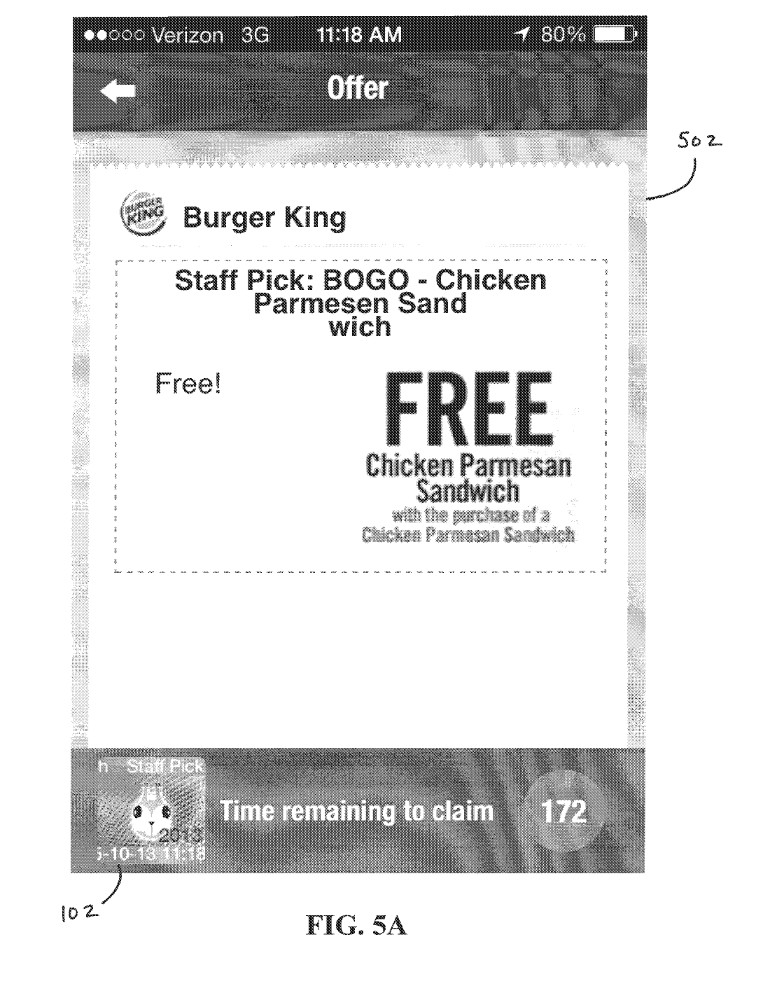

As shown in FIG. 3, the third layer is dynamic and formed by a predefined image representing the shade of the icon (i.e., layer 2). According to some embodiments, the image can be moved according to the gyroscope and accelerometer information of the mobile device. For example, when the device's screen is orientated towards the user (positive pitch), the image representing the shade can move downward and, conversely, when the device's screen is orientated away from the user (negative pitch), the image representing the shade can move upward on the display of the mobile device. Similarly, when the device's screen is orientated towards the right (positive roll), the shade can move to the left and, conversely, when the device's screen is orientated towards the left (negative roll), the shade can move to the right. In further embodiments, simply touching the user interface of the mobile device will cause the DSPH to move in a continuous or on-demand manner.

Referring again to FIG. 2, a fourth layer is static and formed by a computer-generated image written infinitely as lines of text in a specific simulated 3D design. The footer bar of the DSPH can be used to display the current UTC date and time. The text in the footer bar can be continuously sliding from left to right. The speed at which the text is sliding can be defined in a manner that the whole text is displayed in a specific number of seconds before it starts again. This timing can be identical to the one used in the header bar and for the DSPH rotation.

In certain embodiments, a barcode or other element utilized to read the electronic coupon is embedded within a given layer of the DSPH. For example, one of the static layers shown in FIG. 2 may comprise data that can be read by an electronic coupon or barcode reader to identify the necessary information to validate and redeem the coupon.

As will be understood and appreciated, the specific number and composition of layers described and shown in connection with FIGS. 2 and 3 is provided for exemplary purposes only. Any number of layers (or a single layer) can be used with aspects of the present disclosure as will occur to one of ordinary skill in the art.

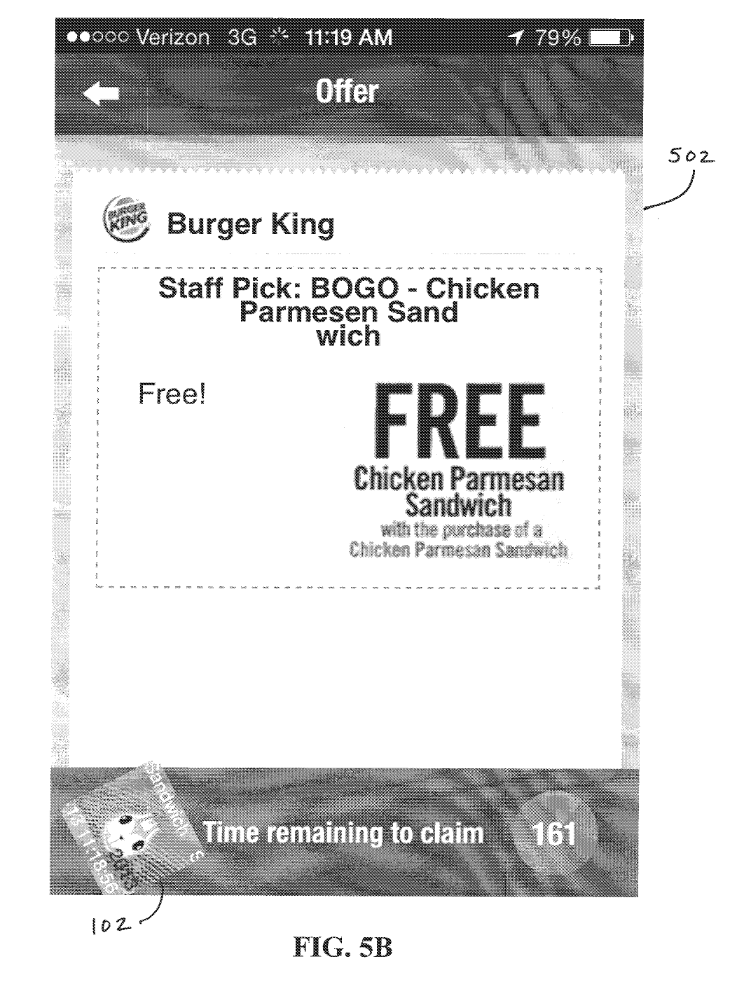

Referring now to FIG. 4, the DSPH 102 can be touch-sensitive such that, when the user clicks on it via the mobile device interface, it begins a 360° clock-wise rotation. The speed at which the DSPH rotates can be programmed such that the 360° rotation takes place in the same amount of time used to slide the text across the header and footer bar. During the rotation, all the dynamic elements of the image (e.g., the header and footer bars, the shading) can be moving.

In order to limit accessibility by an unauthorized user, the DSPH creation code algorithm can be directly encoded within the native application or the web server used to transmit the electronic coupon to the mobile device. Furthermore, all the communications between the applications and the web server, which provides the content of the application, can be encrypted (e.g., by a 256 bit SSL Certificate).

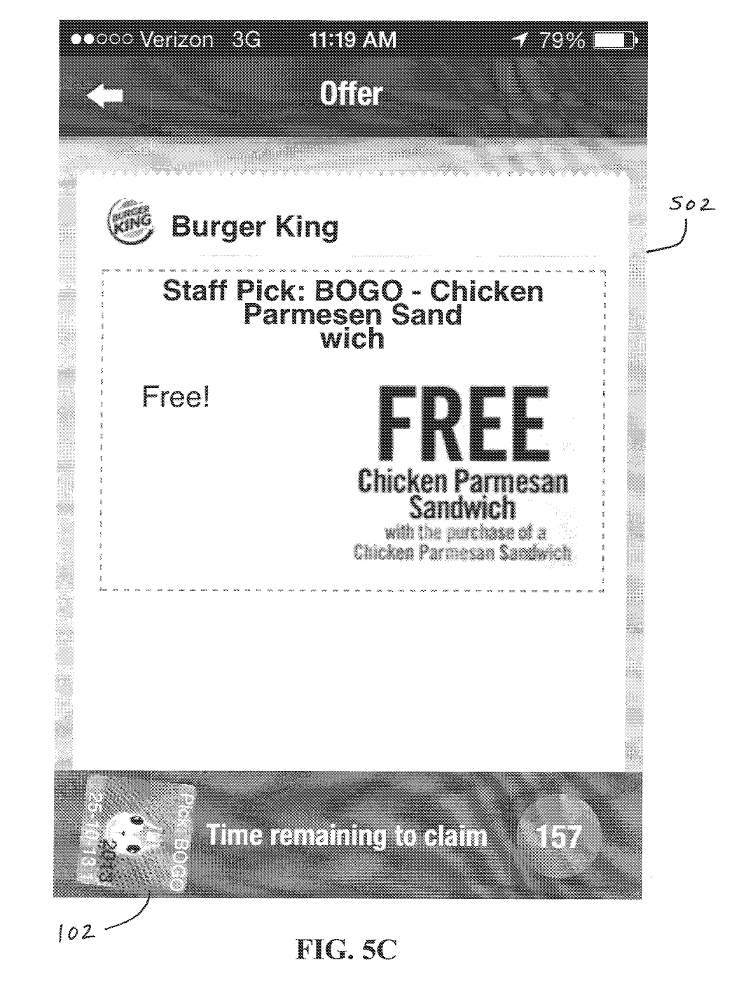

FIGS. 5A-5C illustrate exemplary mobile device screens 502 showing exemplary electronic coupons displayed thereon. As shown in the succession of screens 5A-5C, the DSPH 102 is rotating as the time allotted to redeem the electronic coupon counts down. As described previously, the rotation or movement of the DSPH 102 on a mobile device can be predetermined according to a set of predefine parameters, or the movement can be on-the-fly in response to the physical movement of the mobile device.

In certain embodiments of the present disclosure, a centrally-located server (e.g., a web server) maintains the electronic coupons and related content. Periodically or upon request, the central server transmits the electronic coupons to a plurality of mobile devices. Accordingly, the mobile devices receive the electronic coupons and store them in local memory for a predetermined period of time. In one embodiment, the electronic coupons are managed by a mobile device application. When a given mobile device receives a request for display of a given electronic coupon, the mobile device application retrieves the data corresponding to the coupon and displays it on the mobile device user interface. If the mobile device application receives an indication for activation of the DSPH embedded within the electronic coupon, then the application retrieves specific and predetermined instructions (e.g., computer code or algorithms) that dictate the corresponding movement of the DSPH. For example, the indication of activation may be movement of the mobile device itself, or interaction by a user with the user interface of the device, etc. Upon retrieving the predetermined instructions, the mobile device application causes the DSPH to move on the mobile device display/user interface accordingly.

According to certain embodiments, the DSPH may comprise a hologram image, or simply a moving icon that is capable of being controlled and interacted with by a mobile device user.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method of verifying the authenticity of an electronic coupon, the method comprising the steps of:
transmitting the electronic coupon to a mobile device of a consumer, the electronic coupon comprising an image which comprises one or more visual elements displayed on the screen of the mobile device, wherein at least one of the visual elements is a moving visual element capable of moving when activated by a user of the electronic device; and
verifying the authenticity of the electronic coupon, wherein verifying comprises activation of the electronic coupon upon presentation of the electronic coupon by the consumer, wherein observation of the movement of the moving visual element upon activation confirms the authenticity of the electronic coupon.

2. The method of claim 1, wherein the screen of the mobile device is touch-sensitive, wherein the moving visual element of the electronic coupon moves when the image is touched on the screen of the mobile device.

3. The method of claim 1, wherein the mobile device comprises a gyroscope and/or an accelerometer and wherein the visual element of the electronic coupon moves in response to the gyroscope and/or accelerometer information of the device.

4. The method of claim 1, wherein the mobile device comprises a gyroscope and wherein the visual element of the electronic coupon moves when the mobile device is tilted.

5. The method of claim 1, wherein the electronic coupon comprises the following superimposed visual elements:
an image of the current year;
an icon with a transparent background;
shading for the icon; and
a pseudo-3D image.

6. The method of claim 5, wherein the shading for the icon moves upon activation and wherein the image of the current year, the icon and the pseudo-3D image are fixed.

7. The method of claim 5, wherein the electronic coupon further comprises a header bar and/or a footer bar and wherein the header bar and/or the footer bar comprise scrolling text.

8. The method of claim 7, wherein the electronic coupon rotates when activated and wherein the scrolling text in the header and/or footer bars continues to scroll while the electronic coupon rotates.

9. The method of claim 8, wherein the screen of the mobile device is touch-sensitive and wherein the electronic coupon rotates when the image is touched on the screen of the mobile device.

10. The method of claim 8, wherein the electronic coupon completes one rotation in the same time that the text scrolls across the header and/or footer bar.

11. The method of claim 7, wherein the header bar scrolls the name of an entity issuing the electronic coupon and/or the footer bar scrolls the current date or the current date and time.

12. The method of claim 1, wherein the electronic coupon comprises a static bar code image.

13. The method of claim 1, wherein the electronic coupon further comprises a countdown which removes the electronic coupon from the mobile device.

14. The method of claim 1, wherein the electronic coupon is created by a code algorithm which is directly encoded within the electronic coupon image data on the mobile device or which is directly encoded on a web server used to transmit the electronic coupon to the consumer.

15. The method of claim 14, wherein communication between the mobile device and the web server are encrypted.

16. A computer readable medium comprising instructions to manipulate a processor, the instructions comprising instructions to:
send display data for an electronic coupon image to the mobile device of a consumer, wherein the display data comprises one or more visual elements displayed on the screen of the mobile device, wherein at least one of the visual elements is a moving visual element capable of moving when activated by a user of the electronic device; and
activate the moving visual element when an input is received from a user of the mobile device.

17. The computer readable medium of claim 16, wherein the screen of the mobile device is touch-sensitive, and wherein the instructions to activate the moving visual element include instructions to move the moving visual element when the image is touched on the screen of the mobile device.

18. The computer readable medium of claim 16, wherein the mobile device comprises a gyroscope and/or an accelerometer and wherein the instructions to activate the moving visual element include instructions to move the moving visual element in response to the gyroscope and/or accelerometer information of the device.

19. The computer readable medium of claim 16, wherein the mobile device comprises a gyroscope and wherein the instructions to activate the moving visual element include instructions to activate the moving visual element of the electronic coupon when the mobile device is tilted.

20. A method for displaying an interactive digital image with respect to an electronic coupon on a mobile device, comprising the steps of:
displaying an electronic coupon having an interactive digital image on a display screen of a mobile device;
receiving an indication of physical interaction by a mobile device user with the digital image via the mobile device;
retrieving movement instructions indicating predetermined movement of the digital image with respect to the display screen of the mobile device based on the physical interaction with the mobile device by the mobile device user; and
displaying the predetermined movement of the digital image of the electronic coupon via the display screen of the mobile device.

21. The method of claim 20, wherein the physical interaction by the mobile device user with the mobile device comprises physical movement of the mobile device.

22. The method of claim 20, wherein the physical interaction by the mobile device user with the mobile device comprises swiping the display screen of the mobile device.
